(19) United States
(12) Patent Application Publication
(10) Pub. No.: US 2026/0203282 A1
(43) Pub. Date: Jul. 16, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Shota IHORI, Kanagawa (JP); Atsushi NOGAMI, Kanagawa (JP)

(21) Appl. No.: 19/446,134

(22) Filed: Jan. 12, 2026

(30) Foreign Application Priority Data
Jan. 15, 2025 (JP) 2025-005646

(51) Int. Cl. G06F 16/242; G06F 16/248

(52) U.S. Cl. CPC G06F 16/2448; G06F 16/248

(57) ABSTRACT

An information processing apparatus comprises at least one memory storing a program, at least one processor that, upon execution of the program, is configure to obtain, as a modification rate, an extent in which a deliverable generated by generative AI based on a series of prompts is modified to a deliverable generated by the generative AI based on a series of prompts obtained by changing a portion of the series of prompts, determine, based on the modification rate, a changeable prompt among the series of prompts, and output the determined prompt.

### BACKGROUND

### Field of the Technology

The present disclosure relates to generative AI technology.

### Description of the Related Art

The growth of AI technology resulted in the development of a technology called generative AI in which a learning model is generated in advance through training using various types of data, and data is input to the learning model in order to generate or modify various pieces of content. Generative AI has been developed and is used in many use cases. For example, generating a new image by inputting a text prompt (hereinafter, a prompt) to a learning model that has been trained using a large number of images. In another case, prompts are input in order to conduct a conversation-like chat. In another use case generative AI is used to create a summary of long text and generate new text. In addition, generative AI is used to generate various types of content such as video, audio, and program code.

In the field of generative AI for images, with conventional generative AI, an instruction is issued using a short prompt, and a simple image is generated, as disclosed in Japanese Patent No. 7395686. Japanese Patent No. 7395686 discloses technology that generates an image in which non-textural characteristics are maintained in a better manner as a result of inputting text to a style-based generative adversarial network.

However, the growth of generative AI technology resulted in generative AI that generates a complex image when a long prompt is input. An example of this is disclosed in "High-Resolution Image Synthesis with Latent Diffusion Models" by Robin Rombach and four others, CVPR 2022, June 2022, p. 10674–10685. Therein, a technology that uses a diffusion model to similarly generate images from text is disclosed. The model generated using this technique is called Stable Diffusion, which has been widely used in recent years in the field of image generation.

In the case where such generative AI is used, in order to obtain a desired deliverable, a user needs skill in the technique of "prompt engineering", which is the inputting of an appropriate prompt to a model. However, it is difficult for a beginner in generative AI to acquire skill in this technique, and a large amount of trial and error is required for the user to obtain a desired deliverable.

Meanwhile, there are platforms that sell prompts. For example, PromptBase is a Web site on which prompts that satisfy various use cases can be sold and purchased by users. For example, product pages of prompts for image generation show the outlines and prices of prompts, samples of images that have been generated using such prompts, and the like. The prompts are hidden, and are disclosed to the user when the user has purchased a product.

There are cases where a user wishes to generate a desired deliverable by purchasing a prompt from an expert in prompt engineering with use of such platforms. Also, a deliverable desired by a user may be an image similar to the sample generated image, or may be a unique image that is slightly different from the sample generated image. However, as it is difficult for a beginner in prompt engineering to control prompts, it is expected that a problem will arise where a user does not understand which part of the prompt needs to be altered to generate a deliverable desired by the user.

### SUMMARY

The present disclosure provides a technique for more easily outputting prompts that can be changed to generate a deliverable with use of generative AI.

According to the aspect of the present disclosure, there is provided an information processing apparatus, comprising: at least one memory storing a program; at least one processor that, upon execution of the program, is configure to obtain, as a modification rate, an extent in which a deliverable generated by generative AI based on a series of prompts is modified to a deliverable generated by the generative AI based on a series of prompts obtained by changing a portion of the series of prompts; determine, based on the modification rate, a changeable prompt among the series of prompts; and output the determined prompt.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a block diagram showing an exemplary hardware configuration of a client terminal apparatus 100.

FIG. 1B is a block diagram showing an exemplary hardware configuration of a server apparatus 200.

FIG. 2 is a diagram showing an exemplary configuration of a system.

FIG. 3A is a block diagram showing an exemplary functional configuration of the client terminal apparatus 100.

FIG. 3B is a block diagram showing an exemplary functional configuration of the server apparatus 200.

FIG. 3C is a block diagram showing an exemplary functional configuration of the server apparatus 200.

FIG. 4 is a diagram showing an exemplary configuration of a Web page 400.

FIG. 5A is a flowchart of processing of the client terminal apparatus 100.

FIG. 5B is a flowchart of processing of the server apparatus 200.

FIG. 6 is a diagram showing an exemplary configuration of a table in which, for each modification rate, a disclosure rate corresponding to the modification rate is registered.

FIG. 7 is a diagram showing an exemplary configuration of a table in which, for each partial prompt, a priority level of the partial prompt is registered.

FIG. 8 is a diagram showing an example of a table in which the prompts that are selected as "changeable prompts" are organized for each disclosure rate.

FIG. 9 is a flowchart of processing of the server apparatus 200.

FIG. 10 is a diagram showing an exemplary configuration of a table in which, for each attribute information of a user, a disclosure rate corresponding to the attribute information is registered.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

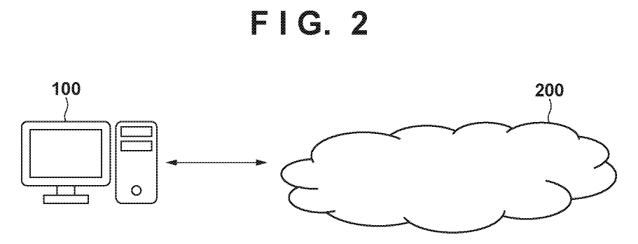

As shown in FIG. 2, a system according to the present embodiment includes a client terminal apparatus 100 that is an information processing apparatus on the client side, and a server apparatus 200 that is an information processing apparatus on the cloud side, and the client terminal apparatus 100 and the server apparatus 200 are configured to be capable of performing data communication with each other via a network, such as a LAN and the Internet.

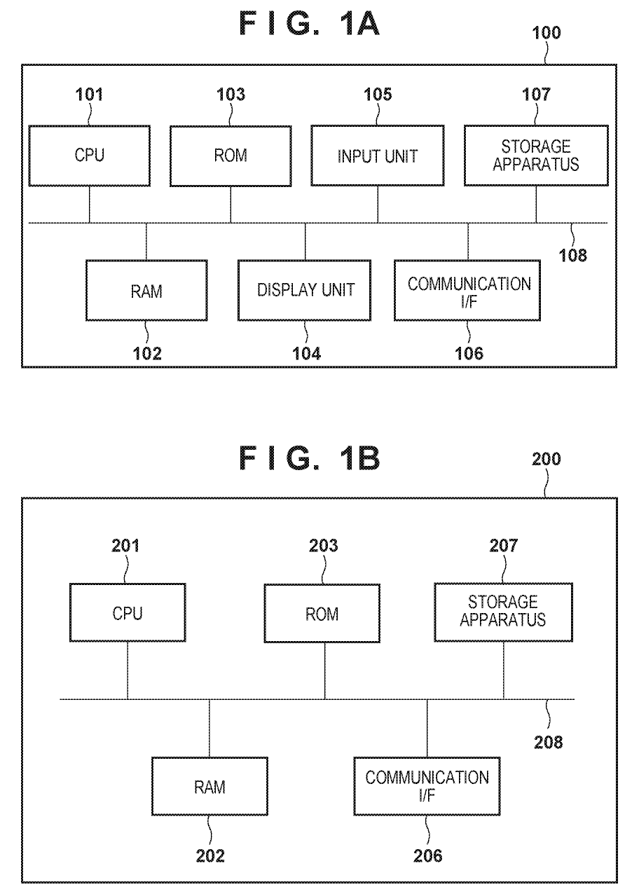

First, an exemplary hardware configuration of the client terminal apparatus 100 will be described using a block diagram of FIG. 1A. The client terminal apparatus 100 is a computer apparatus, such as a PC, a smartphone, and a tablet terminal apparatus.

A CPU 101 executes various types of processing with use of computer programs and data stored in a RAM 102. In this way, the CPU 101 performs overall operation control on the client terminal apparatus 100, and also executes or controls various types of processing that are described as processing executed by the client terminal apparatus 100.

A RAM 102 includes an area for storing computer programs and data loaded from a ROM 103 and a storage apparatus 107, and an area for storing computer programs and data received from an external apparatus via a communication I/F 106. Furthermore, the RAM 102 includes a working area that is used when the CPU 101 executes various types of processing. In this way, the RAM 102 can provide various types of areas as appropriate.

The ROM 103 stores setting data of the client terminal apparatus 100, a computer program and data related to activation of the client terminal apparatus 100, computer programs and data related to basic operations of the client terminal apparatus 100, and the like.

A display unit 104 includes a liquid crystal screen or a touch panel screen, and can display a result of processing by the CPU 101 with use of images, characters, and the like. Note that the display unit 104 may be a projection apparatus that projects images and characters, such as a projector.

An input unit 105 is a user interface, such as a keyboard, a mouse, and a touch panel, and various types of information and instructions can be input to the client terminal apparatus 100 through a user's operation thereon. The communication I/F 106 is a communication interface for the client terminal apparatus 100 to perform data communication with an external apparatus via the network.

The storage apparatus 107 is a large-capacity nonvolatile storage apparatus from/to which computer programs and data can be read/written, such as a hard disk drive and an SSD. An OS, computer programs and data for causing the CPU 101 to execute or control various types of processing that are described as processing executed by the client terminal apparatus 100, and the like are saved in the storage apparatus 107.

Note that the storage apparatus 107 may be a flexible disk (FD), an optical disc like a compact disc (CD), a magnetic or optical card, an IC card, a memory card, or the like that is attachable to and removable from the client terminal apparatus 100.

All of the CPU 101, RAM 102, ROM 103, display unit 104, input unit 105, communication I/F 106, and storage apparatus 107 are connected to a system bus 108. Next, an exemplary hardware configuration of the server apparatus 200 will be described using blocks of FIG. 1B.

A CPU 201 executes various types of processing with use of computer programs and data stored in a RAM 202. In this way, the CPU 201 performs overall operation control on the server apparatus 200, and also executes or controls various types of processing that are described as processing executed by the server apparatus 200.

A RAM 202 includes an area for storing computer programs and data loaded from a ROM 203 and a storage apparatus 207, and an area for storing computer programs and data received from an external apparatus via a communication I/F 206. Furthermore, the RAM 202 includes a working area that is used when the CPU 201 executes various types of processing. In this way, the RAM 202 can provide various types of areas as appropriate.

The ROM 203 stores setting data of the server apparatus 200, a computer program and data related to activation of the server apparatus 200, computer programs and data related to basic operations of the server apparatus 200, and the like. The communication I/F 206 is a communication interface for the server apparatus 200 to perform data communication with an external apparatus via the network.

The storage apparatus 207 is a large-capacity nonvolatile storage apparatus from/to which computer programs and data can be read/written, such as a hard disk drive and an SSD. An OS, computer programs and data for causing the CPU 201 to execute or control various types of processing that are described as processing executed by the server apparatus 200, and the like are saved in the storage apparatus 207.

Note that the storage apparatus 207 may be a flexible disk (FD), an optical disc like a compact disc (CD), a magnetic or optical card, an IC card, a memory card, or the like that is attachable to and removable from the server apparatus 200. All of the CPU 201, RAM 202, ROM 203, communication I/F 206, and storage apparatus 207 are connected to a system bus 208.

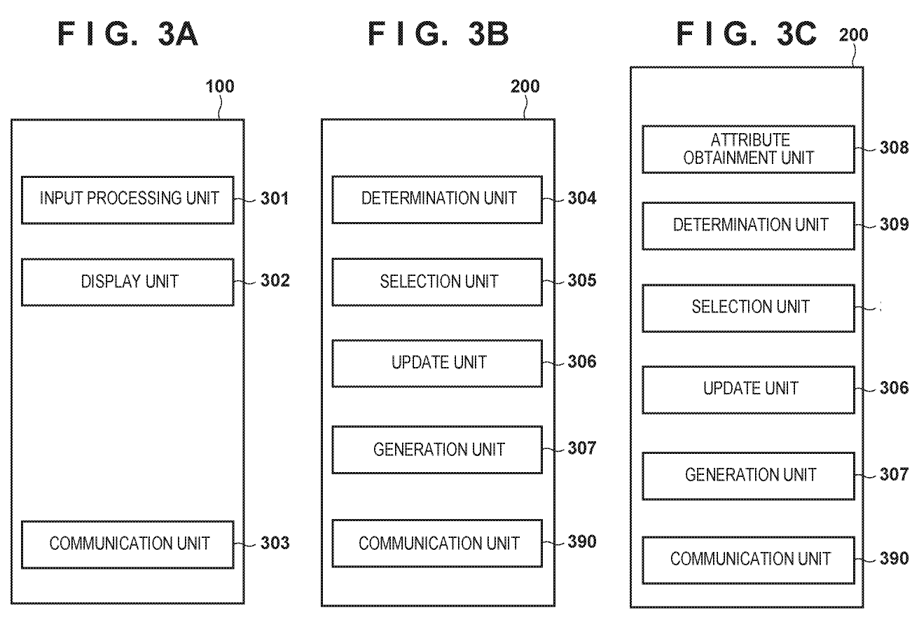

An exemplary functional configuration of the client terminal apparatus 100 according to the present embodiment is shown in a block diagram of FIG. 3A. Also, an exemplary functional configuration of the server apparatus 200 according to the present embodiment is shown in a block diagram of FIG. 3B.

The present embodiment will be described in relation to a case where each functional unit shown in FIGS. 3A and 3B is implemented as software (a computer program). Hereinafter, each functional unit shown in FIG. 3A may be described as a main executor of processing whereby the functions of each functional unit shown in FIG. 3A are implemented by the CPU 101 executing a computer program corresponding to the functional unit. Similarly, hereinafter, each functional unit shown in FIG. 3B may be described as a main executor of processing whereby the functions of each functional unit shown in FIG. 3B are implemented by the CPU 201 executing a computer program corresponding to the functional unit. Note that one or more of the functional units shown in FIGS. 3A and 3B may be implemented as hardware.

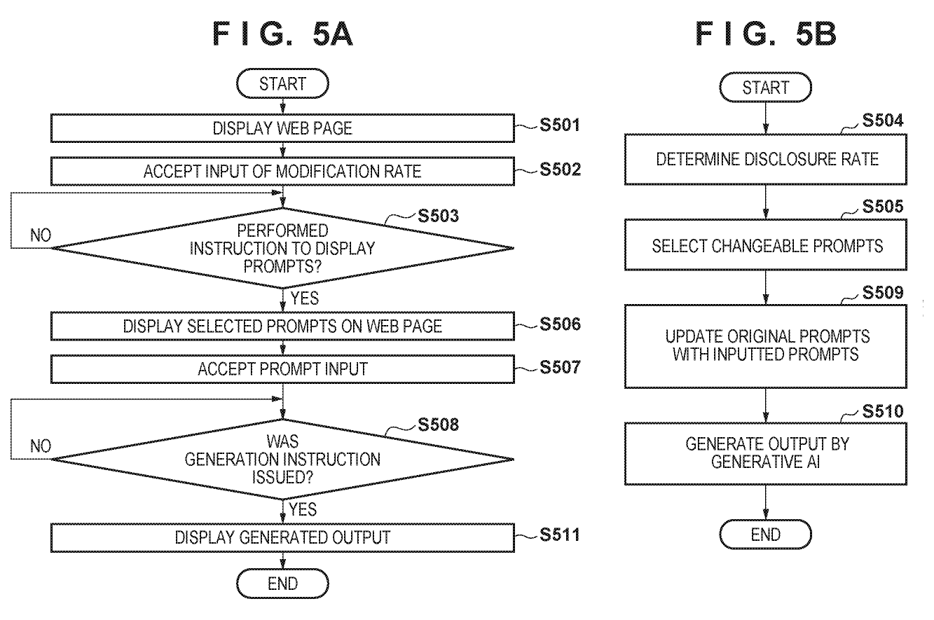

Processing executed by the client terminal apparatus 100 will be described in accordance with a flowchart of FIG. 5A. Processing according to the flowchart of FIG. 5A is realized by the CPU 101 executing a computer program corresponding to each functional unit shown in FIG. 3A.

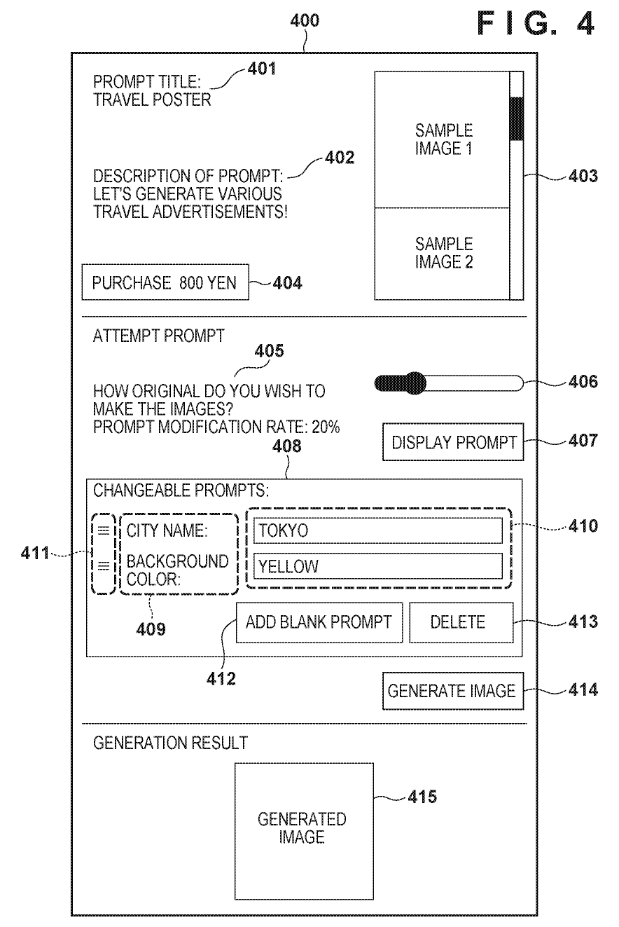

In step S501, a display unit 302 causes the display unit 104 of the client terminal apparatus 100 to display a Web page 400 shown as an example in FIG. 4. Thereafter, the display unit 302 performs control on display of the Web page 400.

The Web page 400 is a site (Web page) that is a source of prompts that can be obtained by users (e.g. via purchase) and the obtained prompts are usable to cause generative AI to generate images. For example, this Web page 400 is provided by the server apparatus 200. For example, when a user has issued an instruction for accessing the Web page 400 by operating the input unit 105, the client terminal apparatus 100 accesses the Web page 400 provided by the server apparatus 200, and causes the display unit 104 to display the Web page 400. On the Web page 400, a prompt title 401 is a title of products (prompts) introduced on the Web page 400.

A prompt description 402 is a detailed description of the prompts introduced on the Web page 400. The prompt description 402 can include, for example, a description of images that can be generated using the prompts introduced on the Web page 400, and a description of, for example, in which use case these images can be used.

A list 403 is a list of images (sample images) that have been generated by the generative AI with use of the prompts obtained (e.g. via purchase) from on the Web page 400. The number of sample images included in the list 403 may be one, or may be more than one. In a case where the list 403 includes a plurality of sample images, it may allow the plurality of sample images to be viewed by scrolling.

A purchase button 404 is a button for issuing an instruction for purchasing the prompts sold on the Web page 400. When the user has issued an instruction on the purchase button 404 by operating the input unit 105, the client terminal apparatus 100 transmits a purchase instruction to the server apparatus 200; upon receiving this instruction, the server apparatus 200 transmits the prompts sold on the Web page 400 to the client terminal apparatus 100.

A message 405 is a message that inquires of the user the extent of modification of images that the user wishes to generate compared to the sample images in the list 403. This is displayed in order to prompt the user to input a desired modification rate when the user attempts to generate modified images by changing a part of the prompts before purchasing the prompts.

A UI 406 is a UI for inputting a modification rate. FIG. 4 shows a case where the UI 406 is a slider bar; in this case, the user can move the slider bar to the left or right by operating the input unit 105. A smaller modification rate is input as the slider bar is closer to the left edge (= a modification rate of 0%), whereas a larger modification rate is input as the slider bar is closer to the right edge (= a modification rate of 100%).

The UI for inputting a modification rate is not limited to the slider bar, and various UIs can be applied thereto. For example, the user can directly input a numerical value indicating a modification rate as text with use of the input unit 105. Also, for example, the user can select one of radio buttons that respectively correspond to numerical values indicating 0%, 20%, 40%, 60%, 80%, and 100% by operating the input unit 105, thereby inputting the numerical value corresponding to the selected radio button as a modification rate.

For example, when the modification rate has a relatively small value, such as 20%, changes can only be made with respect to prompts that exert a small influence on an image representing a deliverable (partial prompts) among the entire group of the prompts (series of prompts). Also, when the modification rate has a relatively large value, such as 90%, changes can be made with respect to many prompts, including prompts that exert a large influence on an image representing a deliverable (partial prompts).

A display button 407 is a button for causing the Web page 400 to display "changeable prompts" that have been determined by the server apparatus 200 based on the modification rate that has been input using the UI 406.

In step S501, although the above-described prompt title 401, prompt description 402, list 403, purchase button 404, message 405, UI 406, and display button 407 are displayed on the Web page 400 shown as an example in FIG. 4, the later-described portions corresponding to reference numerals 408 to 415 are not displayed thereon.

In step S502, an input processing unit 301 accepts an input of a modification rate, and obtains the modification rate that is input by the user operating the UI 406 with use of the input unit 105. In step S503, the input processing unit 301 determines whether the user has issued an instruction on the display button 407 with use of the input unit 105. In a case where the user has issued an instruction on the display button 407 with use of the input unit 105 as a result of this determination, a communication unit 303 transmits the modification rate obtained in step S502 to the server apparatus 200 via the communication I/F 106, and then processing proceeds to step S506. On the other hand, in a case where the user has not issued an instruction on the display button 407 with use of the input unit 105, processing is placed in a standby state in step S503.

In step S506, the communication unit 303 receives, from the server apparatus 200 via the communication I/F 106, prompts that have been selected as "changeable prompts" by a selection unit 305 in the server apparatus 200 through later-described processing. Then, the display unit 302 causes the Web page 400 to display the received "changeable prompts".

A display region 408 is a region that is displayed when an instruction has been issued on the display button 407, and is a region for displaying the prompts that have been received as "changeable prompts" from the server apparatus 200. A list 409 is a list of the prompts that have been received as "changeable prompts" from the server apparatus 200.

Text boxes 410 include text boxes that respectively correspond to the prompts included in the list 409. In a case where the user wishes to change a current value of a target prompt among the prompts included in the list 409 to another value, the user inputs this another value to the text box corresponding to the target prompt in the text boxes 410 with use of the input unit 105. In the example of FIG. 4, the user has input "Tokyo" as a value of a prompt "City Name", and has input "Yellow" as a value of a prompt "Background Color", with use of the input unit 105.

A UI 411 is a UI for changing the order of arrangement when the changeable prompts are input to the generative AI. This can be used for fine adjustment of prompts because, in general, terms and clauses at a front part of prompts of the generative AI significantly contribute to a deliverable. Furthermore, this can also prompt a beginner in prompt engineering who does not have the above-described knowledge to operate the order of partial prompts.

An addition button 412 is a button for issuing an instruction for adding a region in which the user can input any prompt in addition to the changeable prompts. When the user has issued an instruction on the addition button 412 with use of the input unit 105, a new text box is additionally displayed, thereby allowing the user to input a new prompt.

A deletion button 413 is a button for issuing an instruction for deleting a changeable prompt(s). A generation button 414 is a button for causing the generative AI to generate an image based on the current prompts.

In step S507, the input processing unit 301 accepts a user operation on the Web page 400. For example, when the input processing unit 301 has accepted inputting of values of prompts to the aforementioned text boxes 410, an instruction issued on the addition button 412, an instruction issued on the deletion button 413, and the like, it executes corresponding processing.

In step S508, the input processing unit 301 determines whether the user has issued an instruction on the generation button 414 with use of the input unit 105. In a case where the user has issued an instruction on the generation button 414 with use of the input unit 105 as a result of this determination, the communication unit 303 transmits the prompts (values) set on the Web page 400 to the server apparatus 200 via the communication I/F 106, and processing proceeds to step S511. The "values of prompts set on the Web page 400" include, for example, the values of prompts input to the text boxes 410, the values of prompts input to text boxes that have been added by issuing an instruction on the addition button 412, and so forth. On the other hand, in a case where the user has not issued an instruction on the generation button 414 with use of the input unit 105, processing is placed in a standby state in step S508.

In step S511, the communication unit 303 receives an image transmitted from the server apparatus 200 (an image generated through later-described processing by a generation unit 307) via the communication I/F 106. Then, the display unit 302 causes the Web page 400 to display the received image as a generated image 415.

Next, processing executed by the server apparatus 200 will be described in accordance with a flowchart of FIG. 5B. Processing according to the flowchart of FIG. 5B is realized by the CPU 201 executing a computer program corresponding to each functional unit shown in FIG. 3B.

In step S504, a determination unit 304 receives a modification rate transmitted from the client terminal apparatus 100 via the communication I/F 206, and obtains (determines) "a disclosure rate indicating the extent to which a prompt is to be disclosed to a user and made changeable among the entire group of prompts (series of prompts)" based on the received modification rate. The following describes an example of a method for obtaining a disclosure rate based on a modification rate.

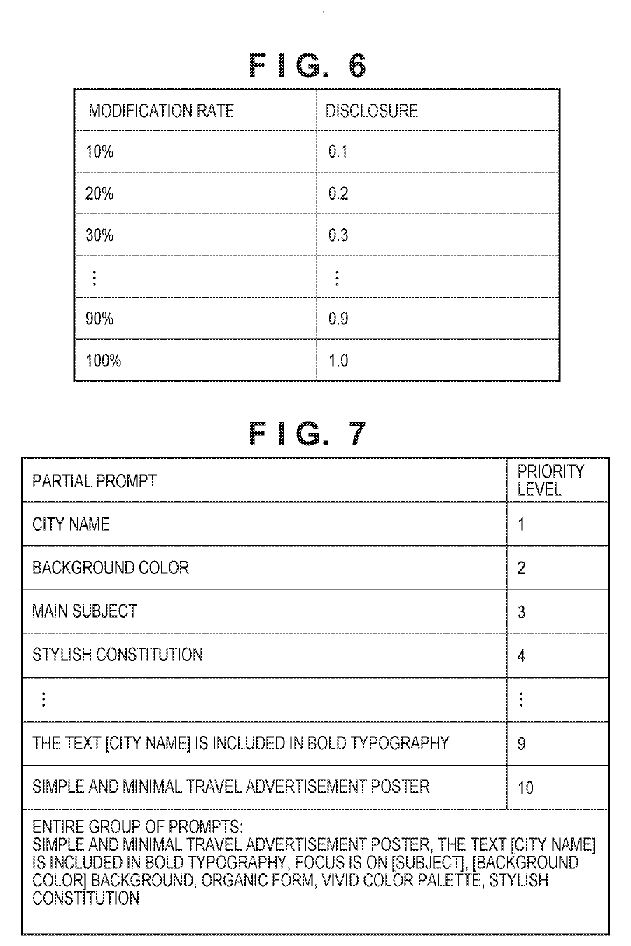

In the present embodiment, a table that is configured as shown as an example in FIG. 6 is registered with the server apparatus 200 in advance. For each modification rate, a disclosure rate corresponding to this modification rate is registered with the table of FIG. 6. In the example of FIG. 6, "0.2" is registered as a disclosure rate corresponding to a modification rate of "20%". The determination unit 304 obtains, from the table of FIG. 6, the disclosure rate corresponding to the modification rate received from the client terminal apparatus 100.

In step S505, based on the disclosure rate obtained in step S504, the selection unit 305 selects "changeable prompts" that are to be disclosed to the user. The following describes an example of a method for selecting "changeable prompts" based on a disclosure rate.

In the present embodiment, a table that is configured as shown as an example in FIG. 7 is registered with the server apparatus 200 in advance. For each prompt (partial prompt), a priority level of this partial prompt is registered with the table of FIG. 7. The example of FIG. 7 indicates that a priority level of the partial prompt "City Name" is 1, and the partial prompt "City Name" is given the highest level of priority in being disclosed and changed. Also, the lowest part of the table of FIG. 7 shows prompts (the entire group of prompts) that can be purchased on the Web page 400.

Furthermore, in the present embodiment, it is assumed that a correspondence relationship between the disclosure rates and the priority levels has been set in advance. For example, it is assumed that the priority levels of 1, 2, 3, 4, 5, 6, 7, 8, 9, and 10 are placed in correspondence with the disclosure rates 0.1, 0.2, 0.3, 0.4, 0.5, 0.6, 0.7, 0.8, 0.9, and 1.0, respectively, in advance.

The table shown as an example in FIG. 7 (the set including the prompts and the priority levels of the prompts) is, for example, a table that is generated in advance by a seller of products (prompts) sold on the Web page 400 and uploaded to the server apparatus 200. When the server apparatus 200 has received the table transmitted (uploaded) by a terminal apparatus of the seller, it saves the received table in the storage apparatus 207.

The selection unit 305 obtains the priority level corresponding to the disclosure rate obtained in step S504, and selects the prompts corresponding to priority levels equal to or higher than the obtained priority level in the table of FIG. 7 as "changeable prompts". For example, in a case where the disclosure rate obtained in step S504 is "0.3", the priority level corresponding to this disclosure rate is "3", and thus the selection unit 305 selects the prompts corresponding to the priority levels equal to or higher than the priority level of "3", namely "1", "2", and "3", as "changeable prompts". In the example of FIG. 7, the selection unit 305 selects the prompt "Main Subject" corresponding to the priority level of "3", the prompt "Background Color" corresponding to the priority level of "2", and the prompt "City Name" corresponding to the priority level of "1" as "changeable prompts". As the disclosure rate is "0.3", which is a relatively small number, partial prompts that do not cause a significant modification in a generated image compared to the image generated using the original prompts are selected as "changeable prompts". If the number of the disclosure rate further increases, "changeable prompts" are selected so as to permit the generated image to be further modified compared to the image generated using the original prompts.

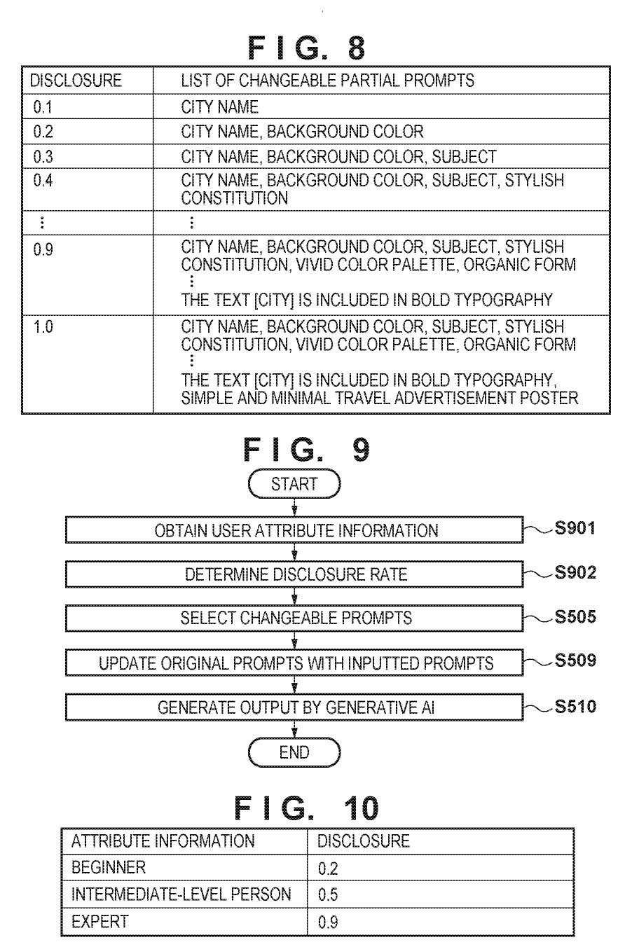

FIG. 8 shows an example of a table in which the prompts that are selected as "changeable prompts" by the selection unit 305 are organized for each disclosure rate. In a case where a higher disclosure rate has been obtained, a larger number of prompts are selected as "changeable prompts". Then, a communication unit 390 transmits (outputs) the prompts that have been selected as "changeable prompts" by the selection unit 305 to the client terminal apparatus 100 via the communication I/F 206.

In step S509, the communication unit 390 receives the values of prompts transmitted from the client terminal apparatus 100 via the communication I/F 206, and an update unit 306 updates current values of these prompts among a group of prompts for image generation to these received values of prompts.

In step S510, the generation unit 307 generates an image through generative AI with use of the aforementioned group of prompts (which can include prompts whose values have been updated in step S509). Then, the communication unit 390 transmits the image generated by the generation unit 307 to the client terminal apparatus 100 via the communication I/F 206.

In this way, the present embodiment makes it possible to present which prompts should be altered to a user depending on to what extent the user wishes to modify a deliverable yielded by generative AI, and assist the generation of a deliverable desired by the user.

Note that although the present embodiment has been described in relation to a case where a deliverable is an image, a deliverable is not limited to an image, and may be text or sounds. That is to say, prompts as products are not limited to prompts for image generation, and may be prompts for text generation or prompts for sound generation.

Furthermore, there may be items for which money is charged depending on the content of operation on the Web page 400 of FIG. 4. For example, there may be a charge for an instruction issued on the display button 407. Also, the Web page 400 is merely an example of a Web page for causing a user to input a modification rate, editing the values of prompts determined by the server apparatus 200 in accordance with the modification rate, and viewing an image generated by generative AI in accordance with the prompts with the edited values; a configuration of a Web page with similar purposes can be changed/modified as appropriate. For example, individual Web pages may be provided in accordance with purposes, such as a Web page for causing a user to input a modification rate, a Web page for editing values of prompts determined by the server apparatus 200 in accordance with the modification rate, and a Web page for viewing an image generated by generative AI in accordance with the prompts with the edited values.

Although the above embodiment has been described in relation to a case where the priority levels corresponding to the respective prompts are defined in the table shown as an example in FIG. 7, a variety of methods are conceivable as a method of determining the priority levels corresponding to the respective prompts.

For example, the server apparatus 200 may increase the priority levels (priority ranks) of prompts that exert a small influence on a deliverable. Methods for the server apparatus 200 to estimate the influence of each prompt on a deliverable include, for example, a method that is based on the general principle of prompt engineering. According to this method, the server apparatus 200 uses the general principle of prompt engineering where "a back part of prompts exerts a small influence on a deliverable", and sets high priority ranks for the back part of prompts. Also, a method that is based on evaluation of influence rates of prompts is another method for the server apparatus 200 to estimate the influence of each prompt on a deliverable. According to this method, the server apparatus 200 measures the influence of each prompt on a deliverable with use of a machine learning model. Then, high priority ranks are set for prompts that exert a small influence. In this way, according to the present modification example, the priority levels can be determined as appropriate even in a case where the priority ranks are not associated with prompts in advance.

In the present embodiment, the differences from the above embodiment will be described, and it is assumed that the present embodiment is similar to the above embodiment unless specifically stated otherwise below. The present embodiment differs from the above embodiment in a method of determining a disclosure rate.

An exemplary functional configuration of the server apparatus 200 according to the present embodiment is shown in a block diagram of FIG. 3C. In FIG. 3C, functional units that are similar to the functional units shown in FIG. 3B are given the same reference numerals thereas, and a description about these functional units is omitted.

Processing of the server apparatus 200 according to the present embodiment will be described in accordance with a flowchart of FIG. 9. In FIG. 9, processing steps that are similar to the processing steps of FIG. 5B are given the same step numbers thereas, and a description about these processing steps is omitted. Processing according to the flowchart of FIG. 9 is realized by the CPU 201 executing a computer program corresponding to each functional unit shown in FIG. 3C.

In the present embodiment, in a case where a user has issued an instruction on the display button 407 with use of the input unit 105 as a result of determination in step S503, the communication unit 303 notifies the server apparatus 200 of information indicating that the instruction has been issued on the display button 407 via the communication I/F 106. The server apparatus 200 that has received this notification starts processing of step S901.

In step S901, an attribute obtainment unit 308 obtains attribute information of a user. The attribute information of the user is information indicating whether the user is "an expert", "an intermediate-level person", or "a beginner" in prompt engineering. The server apparatus 200 causes the user to select a proficiency level in prompt engineering (one of the "expert", "intermediate-level person", and "beginner") when the user registers an account of the Web page 400, and saves the selected proficiency level in the storage apparatus 207. In this case, in step S901, the attribute obtainment unit 308 obtains the proficiency level of the user who is currently logged into the Web page 400 as the attribute information of the user. For example, it is assumed that an extent of modification from an image generated using a series of prompts that have been purchased is lower in a case where the attribute information indicates the beginner than in a case where the attribute information indicates the expert. As a result of the obtainment of the attribute information, a modification rate is obtained as well.

In step S902, a determination unit 309 obtains a disclosure rate corresponding to the modification rate that has been obtained as the attribute information in step S901. In the present embodiment, a table of FIG. 10 is saved in the storage apparatus 207 in advance. For each attribute information of the user, a disclosure rate corresponding to this attribute information is registered with the table of FIG. 10. For example, in a case where the attribute information indicates "beginner", changeable prompts can be limited to those that exert a small influence on a generated image by setting a low disclosure rate. Therefore, in this case, the determination unit 304 obtains a disclosure rate corresponding to the attribute information that has been obtained in step S901 from the table of FIG. 10.

Note that in the present embodiment, when the Web page 400 is displayed, the message 405 and the UI 406 may not be displayed, or the UI 406 may be displayed but inoperable.

Note that although the attribute information is information indicating whether the user is the "expert", "middle-level person", or "beginner" in prompt engineering in the present embodiment, no limitation is intended by this. For example, another type of information related to the user, such as a title of the user and a department to which the user belongs, may be used as the attribute information of the user. Also, for example, information of the number of times the user has purchased prompts in the past, the frequency of the purchase, and the like may be used as the attribute information of the user.

Furthermore, for example, the attribute information of the user may be based on a status where a user is charged on the Web page 400. For example, the attribute information of the user may be information indicating to which one of the following plans a user's account subscribes: 1000 yen, 500 yen, and free of charge per month. Therefore, when a table has been generated with which disclosure rates corresponding to the attribute information of the user are registered, various types of information related to the user can be applied as the attribute information of the user.

Then, in step S505 according to the present embodiment, based on the disclosure rate obtained in step S902, the selection unit 305 selects "changeable prompts" that are to be disclosed to the user.

In this way, according to the present embodiment, prompts can be disclosed in a stepwise manner in consideration of attribute information of a user, and therefore the generation of a deliverable desired by the user can be assisted.

Processing that has been described as processing executed by the server apparatus 200 (except for communication with the client terminal apparatus 100) may be executed by the client terminal apparatus 100. Processing according to the flowcharts of FIGS. 5A and 5B (except for communication between the apparatuses), and processing according to the flowchart of FIG. 9, may be executed in the client terminal apparatus 100. The operations of the client terminal apparatus 100 and the operations of the server apparatus 200 may be carried out on one information processing apparatus.

In this case, the client terminal apparatus 100 may hold the table of FIG. 7 and the table of FIG. 10 in the storage apparatus 107, or may obtain them by downloading them from the server apparatus 200 as appropriate.

Also, the above embodiments have been described in relation to a case where the cloud is implemented using one server apparatus 200. However, no limitation is intended by this, and the cloud may be composed of a plurality of apparatuses; in this case, various types of processing that have been described above as processing executed by the server apparatus 200 are carried out using these plurality of apparatuses.

The numerical values, processing timings, the order of processing, the main executors of processing, and the configuration/obtainment method/transmission destination/transmission source/storage location and the like of data (information) and a Web page that are used in the above-described embodiments and modification example are presented as examples to provide a specific description, and there is no intention to limit them to such examples.

Also, parts or all of the above-described embodiments and modification example may be used in combination as appropriate. Furthermore, parts or all of the above-described embodiments and modification example may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-005646, filed January 15, 2025, which is hereby incorporated by reference herein in its entirety.

What is claimed is:

1. An information processing apparatus, comprising:
at least one memory storing a program;
at least one processor that, upon execution of the program, is configure to
obtain, as a modification rate, an extent in which a deliverable generated by generative AI based on a series of prompts is modified to a deliverable generated by the generative AI based on a series of prompts obtained by changing a portion of the series of prompts;
determine, based on the modification rate, a changeable prompt among the series of prompts; and
output the determined prompt.

2. The information processing apparatus according to claim 1, wherein execution of the stored program further configures the at least one processor to
receive, from a client terminal apparatus, a modification rate input in accordance with a user operation performed on a screen displayed on a display of the client terminal apparatus.

3. The information processing apparatus according to claim 1, wherein execution of the stored program further configures the at least one processor to
obtain a modification rate that corresponds to attribute information of a user.

4. The information processing apparatus according to claim 1, wherein
the series of prompts have corresponding priority levels, and the changeable prompt is determined to be a prompt with priority level that is higher than or equal to a priority level corresponding to the modification rate.

5. The information processing apparatus according to claim 4, execution of the stored program further configures the at least one processor to
estimate an extent of influence of the prompt on the deliverable and determine a priority level of the prompt in accordance with a result of the estimation.

6. The information processing apparatus according to claim 1, wherein execution of the stored program further configures the at least one processor to
transmit the determined prompt a client terminal apparatus.

7. The information processing apparatus according to claim 1, wherein execution of the stored program further configures the at least one processor to
generate the deliverable via the generative AI by using, as an input to the generative AI, a prompt having a value updated by a client terminal apparatus; and
transmit the generated deliverable to the client terminal apparatus.

8. The information processing apparatus according to claim 1, wherein execution of the stored program further configures the at least one processor to
obtain a set of prompts each including a prompt and priority levels of the prompt.

9. The information processing apparatus according to claim 1, wherein execution of the stored program further configures the at least one processor to
obtain the modification rate input in accordance with a user operation performed on a screen of the information processing apparatus.

10. The information processing apparatus according to claim 1, wherein execution of the stored program further configures the at least one processor to
cause a screen of the information processing apparatus to display the prompt determined by the determination unit.

11. The information processing apparatus according to claim 1, wherein execution of the stored program further configures the at least one processor to
generate the deliverable via the generative AI using the determined prompt; and
cause a screen of the information processing apparatus to display the generated deliverable.

12. An information processing method executed by an information processing apparatus, comprising:
obtaining, as a modification rate, an extent in which a deliverable generated by generative AI based on a series of prompts is modified to a deliverable generated by the generative AI based on a series of prompts obtained by changing a portion of the series of prompts;
determining, based on the modification rate, a changeable prompt among the series of prompts; and
outputting the determined prompt.

13. A non-transitory computer-readable storage medium storing a computer program for causing a computer to function as:
an obtainment unit configured to obtain, as a modification rate, an extent in which a deliverable generated by generative AI based on a series of prompts is modified to a deliverable generated by the generative AI based on a series of prompts obtained by changing a portion of the series of prompts;
a determination unit configured to determine, based on the modification rate, a changeable prompt among the series of prompts; and
an output unit configured to output the prompt determined by the determination unit.
